(19) United States
(12) Patent Application Publication
(10) Pub. No.: US 2010/0078852 A1
(43) Pub. Date: Apr. 1, 2010

(54) Retardation film producing method

(75) Inventor: Kasuke Yamaki, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/585,949

(22) Filed: Sep. 29, 2009

(30) Foreign Application Priority Data
Sep. 30, 2008 (JP) 2008-252183

(51) Int. Cl. B29D 7/00

(52) U.S. Cl. 264/216

(57) ABSTRACT

Dope is cast onto a casting drum to form a casting film. The casting film is cooled on the casting drum to be hardened. The casting film containing a large amount of solvent is peeled as a film from the casting drum. The film is dried in a tenter. Concretely, the film is dried until the residual amount of solvent becomes 60 mass %. Thereafter, the film is further dried by blowing gas at a temperature of at most 105° C. toward the film until the residual amount of solvent becomes 10 mass %. A glass transition temperature of cellulose acylate in the film in which a residual amount of solvent is 10 mass % is denoted by Tg (° C.). The film is subjected to a width increasing process while the temperature of the film is within a range between Tg+10° C. or more and Tg+60° C. or less to obtain a retardation film.

### FIELD OF THE INVENTION

The present invention relates to a method for producing a retardation film for use in a polarizing plate.

### BACKGROUND OF THE INVENTION

A retardation film is used in combination with a liquid crystal layer of a liquid crystal display to convert elliptically-polarized light after passing through the liquid crystal layer into approximately linearly-polarized light. The conversion is caused by mutual effect of their phase differences. Since the liquid crystal layers have own phase difference, it is necessary to select the retardation film in accordance with the liquid crystal layer to be used.

The retardation film is required to have various kinds of optical properties. Concretely, the retardation film capable of achieving high front contrast on the liquid crystal display and having high Re of at least 50 nm is particularly required.

“Re” is a retardation value (unit; nm) in a direction of the plane vertical to a thickness direction of the film, that is, an in-plane retardation value. The “Re” is calculated by the following mathematical expression (1). “Rth” is a retardation value (unit; nm) in the thickness direction of the film. The “Rth” is calculated by the following mathematical expression (2). In the mathematical expressions (1) and (2), “Nx” is a refractive index in a slow axis direction X in the in-plane of the film, “Ny” is a refractive index in a fast axis direction Y in the in-plane of the film, “Nz” is a refractive index in the film thickness direction Z, and “d” is a thickness (nm) of the film.

Re=(Nx−Ny)×d (1)

Rth={(Nx+Ny)/2−Nz}×d (2)

The front contrast is a luminance ratio between the brightest portion (white portion) and the darkest portion (black portion) on the liquid display as viewed from the front side. It is known that the front contrast is increased as a level of the transparency of the retardation film is increased.

In general, as a value representing the level of transparency of the retardation film, there is a haze value. As the haze value is lower, the level of transparency of the film is higher. Accordingly, when a retardation film having a low haze value is used in the liquid crystal display, the front contrast on the liquid crystal display tends to be higher. The attempt to increase the front contrast has been considered to be significant heretofore. Additionally, the target level of the front contrast has been increased more and more recently, and it has been required to further increase the level of transparency of the retardation film in comparison with that of the conventional retardation films. The haze value corresponding to the required target level of transparency is at most 0.5 that is much lower than 1, while the haze value corresponding to the conventional level of transparency is around 1.

The haze value means the degree of clouded state of an inside or a surface of the transparent film, and calculated by the following mathematical expression (3). In a measuring method of the haze value, light transmittance of the film is measured. “Th” is a haze value, “Td” is scattered light transmittance, and “Tt” is all light transmittance.

Th=100×(Td/Tt) (3)

As the retardation film, there are used various kinds of polymer films. For example, there are a cellulose acylate film, a cyclic polyolefin film, a polycarbonate film, a polymethyl methacrylate film, and the like. These films are produced by at least one of a solution casting method and a melt-extrusion method. In order to produce a long retardation film, for example, side edge portions of a long polymer film are held by a holding means such as clips or the like, and tension is applied to the polymer film in the width direction to increase the width of the polymer film. Thereby, Re is increased in the polymer film. Upon the width increasing process, not only increasing of the Re but also adjustment of the haze value is performed in some cases.

Among the above polymer films, the cellulose acylate film is mainly produced by the solution casting method. As well known, in the solution casting method, a dope which is a polymer solution obtained by dissolving a polymer into a solvent is cast onto a support such as a drum or a belt to form a casting film, and the casting film is peeled from the support and dried, to obtain a film. For the purpose of using the cellulose acylate film as the retardation film, the width increasing process described above is performed in the course of the solution casting. Alternatively, the cellulose acylate film produced by the solution casting is subjected to the width increasing process described above.

In a case where a width increasing process is performed in the course of the solution casting, the width increasing process is performed after the residual amount of solvent in the cellulose acylate film becomes extremely low in many cases, because it is not effective to perform the width increasing process with the aim of increasing the Re while the residual amount of solvent in the cellulose acylate film is still high. For example, according to Japanese Patent Laid-Open Publication No. 2002-187960, a cellulose acylate film in which the residual amount of solvent is in the range of 10 to 100 mass % is subjected to a stretching process, such that the width of the cellulose acylate film after the stretching is 1.0 to 4.0 times as wide as the cellulose acylate film before the stretching. Thereby, it is possible to obtain the cellulose acylate film in which Re is in the range of 30 to 300 nm.

A method disclosed in Japanese Patent Laid-Open Publication No. 2002-311245 includes two stretching processes, and the second stretching process is applied to a cellulose acylate film in which the residual amount of solvent is at most 5 mass %. Concretely, a casting film is dried until the residual amount of solvent becomes a value within the range of 70 to 160 mass %, and then peeled as a cellulose acylate film. The peeled cellulose acylate film is further dried until the residual amount of solvent becomes a value within the range of 10 to 50 mass %. Thereafter, the cellulose acylate film starts to be stretched.

Furthermore, according to US Patent Publication No. 7,166,339 (corresponding to International Patent Publication WO 00/65384), a retardation film is formed from cellulose acylate by using a dope to which an aromatic compound having at least two aromatic rings is added. A material which is added for the purpose of increasing retardation and developing the phase difference, such as the aromatic compound having at least two aromatic rings described above, is called as a retardation increasing agent.

The ratio of width increasing performed by the stretching may be increased in order to increase Re. However, as the width increasing ratio is increased, voids are generated in the film, and further the voids become crazes (cracks) in some cases. Some voids and crazes are not clearly visible by eyes, but visible by an optical microscope. The portions of the film which have voids or crazes may be clouded in some cases. This is because the light incident on the film is reflected and scattered on the portions of the film which have the voids or crazes as described above. Accordingly, in the film which includes the voids or crazes, the haze value is increased unfavorably.

According to the methods disclosed in Japanese Patent Laid-Open Publications Nos. 2002-187960 and 2002-311245, although it is possible to obtain the retardation film having high Re by the stretching, the haze value is also increased unfavorably. Therefore, it is impossible to achieve the front contrast high enough to satisfy the level, which has been required for the liquid display recently, by the retardation film. Accordingly, it is impossible to obtain the retardation film having high Re and capable of achieving high front contrast on the liquid crystal display.

According to US Patent Publication No. 7,166,339, the retardation increasing agent is added to the dope to increase Re. However, upon increase in the ratio of the retardation increasing agent in the dope, the retardation increasing agent is not easily dissolved into the dope, and thereby the haze value tends to be increased. Thus, it is impossible to achieve high front contrast on the liquid crystal display by the retardation film. As a result, it is impossible to obtain the retardation film having high Re and cable of achieving high front contrast on the liquid crystal display.

### SUMMARY OF THE INVENTION

In view of the foregoing, an object of the present invention is to provide a method for producing a retardation film in which a haze value is at most 0.5 and Re is at least 50 nm.

A retardation film producing method of the present invention includes a casting step, a first drying step, a second drying step, and a width increasing step. In the casting process, a dope containing cellulose acylate and a solvent is continuously discharged onto a support from a casting die to form a casting film, and the casting film is peeled as a film from the support. In the first drying step, the film is dried by being heated until a residual amount of solvent in the film becomes 60 mass %. In the second drying step, gas at a temperature of at most 105° C. is blown to the film until the residual amount of solvent in the film changes from 60 mass % to 10 mass % to dry the film. In the width increasing step, a width of the film subjected to the second drying step is increased while a temperature of the film is kept within a range between Tg+10° C. or more and Tg+60° C. or less, in which Tg is a glass transition temperature of the cellulose acylate contained in the film having the residual amount of solvent of 10 mass %. In the width increasing step, the width of the film is increased such that a width increasing ratio (%) calculated by a mathematical formula expressed by (L2−L1)/L1×100 becomes a value within the range between 30% or more and 65% or less. A width of the film before the width increasing is denoted by L1, and a width of the film after the width increasing is denoted by L2. Further, it is preferable that the casting film is hardened by cooling the support.

According to the present invention, it is possible to produce the retardation film in which the haze value is at most 0.5 and Re is at least 50 nm.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is a schematic view of a solution casting apparatus according to an embodiment of the present invention;

FIG. 2 is a schematic view of a film held in a tenter;

FIG. 3 is an explanation view showing an increase and a decrease in a width of the film in the tenter; and

FIG. 4 is a schematic view of an off-line stretching apparatus according to another embodiment of the present invention.

### DESCRIPTION OF THE PREFERRED EMBODIMENTS

Hereinafter embodiments of the present invention are described in detail. However, the present invention is not limited to the following embodiments.

[Raw Material]

A publicly-known polymer which can be used for forming a retardation film by a solution casting method may be adopted as a polymer in the present invention. Cellulose acylate is preferably used as the polymer in this embodiment. The cellulose acylate more preferably used in this embodiment satisfies all of the following formulae (I) to (III) for a ratio in esterification of hydroxyl group of cellulose with carboxylic acid, or namely a degree of acyl substitution (hereinafter, referred to as acylation degree).

2.5≦A+B≦3.0 (I)

0≦A≦3.0 (II)

0≦B≦2.9 (III)

In the above formulae (I) to (III), “A” represents a degree of substitution of the hydrogen atom in the hydroxyl group for the acetyl group in cellulose, while “B” represents a degree of substitution of the hydrogen atom in the hydroxyl group for the acyl group with 3 to 22 carbon atoms in cellulose.

Cellulose has glucose units making β-1,4 bond, and each glucose unit has a free hydroxyl group at second, third, and sixth positions. Cellulose acylate is a polymer in which a part of or the whole of the hydroxyl groups are esterified so that the hydrogen is substituted by the acyl group with two or more carbons. When the esterification of one hydroxyl group in the glucose unit is made at 100%, the degree of substitution is 1. As for cellulose acylate, when the esterification of each hydroxyl group at the second, third, and sixth position is made at 100%, the degree of substitution is 3.

Here, DS2 is the degree of substitution of the hydrogen atom in the hydroxyl group at second position per glucose unit to the acyl group, DS3 is the degree of substitution of the hydrogen atom in the hydroxyl group at third position per glucose unit to the acyl group, and DS6 is the degree of substitution of the hydrogen atom in the hydroxyl group at sixth position per glucose unit to the acyl group. A total acylation degree, the value of DS2+DS3+DS6, is preferably in the range of 2.00 to 3.00, more preferably in the range of 2.22 to 2.90, and most preferably in the range of 2.40 to 2.88. Moreover, DS6/(DS2+DS3+DS6) is preferably at least 0.32, more preferably at least 0.322, and most preferably in the range of 0.324 to 0.340.

In the present invention, one or more kinds of the acyl groups may be contained in cellulose acylate. In a case where two or more kinds of acyl groups are in cellulose acylate, it is preferable that one of them is the acetyl group. In a case where a total degree of substitution of the hydroxyl group at the second, the third, and the sixth positions to the acetyl groups and that to acyl groups other than acetyl groups are described as DSA and DSB, respectively, the value of DSA+DSB is preferably in the range of 2.2 to 2.86, and more preferably in the range of 2.40 to 2.80. In addition, DSB is preferably at least 1.50, and more preferably at least 1.7. In the DSB, the percentage of the substitution of the hydroxyl group at the sixth position is at least 28%, preferably at least 30%, more preferably at least 31%, and most preferably at least 32%.

Furthermore, the value of DSA+DSB, in which the hydroxyl group is at the sixth position in cellulose acylate, is preferably at least 0.75, more preferably at least 0.80, and most preferably at least 0.85. Cellulose acylate with such a composition provides excellent solubility in the dope, and the obtained dope is low in viscosity and excellent in filterability. Particularly, if a non-chlorine organic solvent is used, cellulose acylate having the above-described composition is preferable.

The acyl group having at least 2 carbon atoms in cellulose acylate is not limited particularly, and may be either an aliphatic group or an aryl group. Examples of the acyl group are alkylcarbonyl ester of cellulose, alkenylcarbonyl ester of cellulose, aromatic carbonyl ester of cellulose, and aromatic alkylcarbonyl ester of cellulose, and each of them may have further substitutents. Exemplary substitutents are a propionyl group, a butanoyl group, a pentanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a t-butanoyl group, a cyclohexane carbonyl group, an oleoyl group, a benzoyl group, a naphthyl carbonyl group, and a cinnamoyl group. Preferable substituents among these are the propionyl group, the butanoyl group, the dodecanoyl group, the octadecanoyl group, the t-butanoyl group, the oleoyl group, the benzoyl group, the naphthyl carbonyl group, and the cinnamoyl group, and more preferable substituents among these are the propionyl group and the butanoyl group.

Details regarding cellulose acylate are described in paragraphs [0140] to [0195] in Japanese Patent Laid-Open Publication No. 2005-104148. These descriptions are also applicable to the present invention.

The dope may contain retardation increasing agents. The retardation increasing agents are not especially limited, and described in detail in paragraphs [0030] to [0142] of Japanese Patent Laid-Open Publication No. 2006-235483, for example. Further, various additives may be added to the dope. As such additives, there are solvents, plasticizers, deterioration inhibitors, UV absorbents, optical anisotropy controllers, dyes, matting agents, and peeling agents, which are described in detail in paragraphs [0196] to [0516] of Japanese Patent Laid-Open Publication No. 2005-104148. These descriptions are also applicable to the present invention.

The solvent for producing the dope may be aromatic hydrocarbon (for example, benzene, toluene, and the like), halogenated hydrocarbon (for example, dichloromethane, chlorobenzene, and the like), alcohol (for example, methanol, ethanol, n-propanol, n-butanol, diethylene glycol, and the like), ketone (for example, acetone, methyl ethyl ketone, and the like), ester (for example, methyl acetate, ethyl acetate, propyl acetate, and the like), ether (for example, tetrahydrofuran, methyl cellosolve, and the like), and the like. Here, the dope is a polymer solution or a dispersion liquid obtained by dissolving or dispersing polymer(s) in the solvent.

As the solvent compounds for cellulose acylate, the halogenated hydrocarbons having 1 to 7 carbon atoms are preferable, and dichloromethane is most preferable. In view of physical properties such as solubility of triacetyl cellulose (hereinafter referred to as TAC), peelability of a casting film from a support, mechanical strength and optical properties of the film, it is preferable to use at least one sort of the alcohols having 1 to 5 carbon atoms together with dichloromethane. The content of the alcohols is preferably in the range of 2 mass % to 25 mass %, and more preferably in the range of 5 mass % to 20 mass % relative to the total solvent compounds in the solvent. Specific examples of the alcohols are methanol, ethanol, n-propanol, isopropanol, n-butanol, and the like. Among them, methanol, ethanol, n-butanol, or a mixture of them is more preferably used.

In order to reduce adverse influence on the environment to the minimum, a solvent containing no dichloromethane may be used for producing the dope. In this case, the solvent preferably contains ether having 4 to 12 carbon atoms, ketone having 3 to 12 carbon atoms, and ester having 3 to 12 carbon atoms. The solvent also contains a mixture of them in some cases. Note that ether, ketone, and ester may have a cyclic structure. A compound having at least two functional groups thereof (that is, —O—, —CO—, and —COO—) may be used as the solvent. The solvent may contain other functional groups such as alcoholic hydroxyl groups in the chemical structure.

A method for producing a dope to be cast is not especially limited. However, in a case where a dope is cast onto a support to form a casting film, and the casting film is cooled to be hardened, and then peeled from the support as described later, the dope is preferably produced such that the concentration of the solid content such as cellulose acylate in the dope is higher that that in a dope which is to be cast onto a support and dried to be hardened. In this case, preferably used is a so-called flush concentration method, in which a dope having a concentration lower than the target concentration is prepared once, and then the dope is caused to flush by a publicly-known flush device such that part of the solvent is evaporated from the dope.

The concentration of cellulose acylate in the dope to be cast is preferably in the range of 5 mass % to 40 mass %, more preferably in the range of 15 mass % to 30 mass %, and most preferably in the range of 17 mass % to 25 mass %.

Note that a dissolving means, a filtration means, a defoaming means, and an adding means for the materials, raw materials, and additives in the solution casting method for producing the TAC film are described in detail in paragraphs [0517] to [0616] in Japanese Patent Laid-Open Publication No. 2005-104148. These descriptions are also applicable to the present invention.

[Film Producing Apparatus and Method]

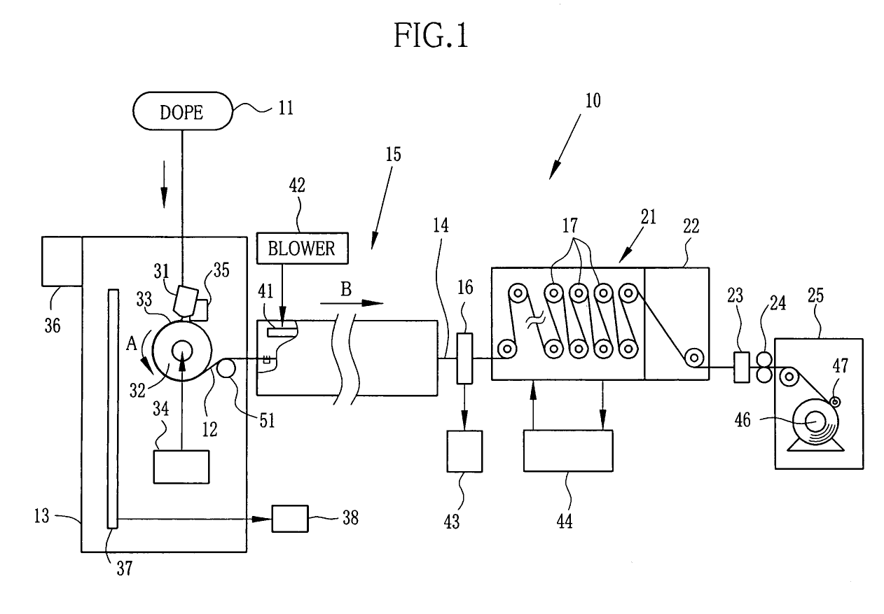

FIG. 1 schematically shows a solution casting apparatus 10 for producing a retardation film according to an embodiment of the present invention. However, the present invention is not limited to the solution casting apparatus 10. Although cellulose acylate is used as a polymer of the dope in this embodiment, other polymers also may be used.

The solution casting apparatus 10 includes a casting chamber 13, a tenter 15, an edge slitting device 16, a drying chamber 21, a cooling chamber 22, a neutralization chamber 23, a pair of knurling rollers 24, and a winding chamber 25 disposed in this order from an upstream side in a conveying direction of a film 12. In the casting chamber 13, a dope 11 is cast onto a support to form a cellulose acylate film (hereinafter abbreviated as film) 12. The film 12 is conveyed in the tenter 15 while side edge portions thereof are held such that a width thereof is increased to form a retardation film 14. Thereafter, the side edge portions of the retardation film 14 are cut off by the edge slitting device 16. The retardation film 14 whose side edge portions has been cut away is bridged over a plurality of rollers 17 and conveyed while being dried in the drying chamber 21. Then, the retardation film 14 is cooled in the cooling chamber 22. An amount of charged voltage of the retardation film 14 is reduced in the neutralization device 23. Side ends of the retardation film 14 are subjected to embossing processing using the pair of knurling rollers 24. Then, the retardation film 14 is wound in the winding chamber 25.

The casting chamber 13 includes a casting die 31 for continuously discharging the guided dope 11, and a casting drum 32 disposed so as to face a dope discharge port of the casting die 31 such that the dope 11 is cast onto a peripheral surface thereof. The casting drum 32 serves as the support rotating in a circumferential direction.

The casting die 31 is provided with a temperature controller (not shown) for controlling the temperature of the casting die 31 such that the temperature of the dope 11 discharged toward the casting drum 32 is kept at a predetermined value. The casting drum 32 is driven to rotate by a driver (not shown) in a rotational direction shown by the arrow A in the drawing. The dope 11 is continuously discharged from the casting die 31 onto the casting drum 32 rotating in the rotational direction A, and thereby the dope 11 is cast onto the peripheral surface of the casting drum 32 to form a casting film 33.

The casting drum 32 is provided with a heat transfer medium circulator 34 for supplying a heat transfer medium at a predetermined temperature to the casting drum 32 so as to control the temperature of the peripheral surface of the casting drum 32. A flow channel for the heat transfer medium (not shown) is provided inside the casting drum 32. The heat transfer medium flows in the flow channel such that the temperature of the peripheral surface of the casting drum 32 is kept at a predetermined value. The surface temperature of the casting drum 32 is appropriately adjusted in accordance with the kind of the solution, the kind of the solid content, the concentration of the dope 11, and the like. Preferably, the casting drum 32 can rotate at high precision such that the rotation speed variation thereof is within 0.2% of the predetermined rotational speed.

A decompression chamber 35 for sucking air is disposed in an upstream side from the casting die 31 in the rotational direction A of the casting drum 32. The decompression chamber 35 sucks air in an area in the upstream side from the dope 11 discharged as a bead such that the pressure in the area in the upstream side from the dope 11 is lower than that in an area in a downstream side from the dope 11.

The casting chamber 13 includes a temperature controlling device 36 and a condenser 37. The temperature controlling device 36 keeps the temperature inside the casting chamber 13 at a predetermined value. The condenser 37 condenses and liquefies the solvent vapor evaporated from the dope 11 and the casting film 33. A recovery device 38 for recovering the solvent vapor condensed and liquefied by the condenser 37 is disposed outside the casting chamber 13.

The tenter 15 disposed in the downstream side from the casting chamber 13 includes an air duct 41. The air duct 41 extends in the conveying direction of the film 12 as shown by the arrow B in the drawing, and blows air at an adjusted temperature toward the film 12 from the above. The inside of the air duct 41 is partitioned into plural sections in the conveying direction B of the film 12. A slit (not shown) extending in a width direction of the film 12 is provided in each of the sections so as to face a film conveying path. Air is fed through each of the slits to the air duct 41 by a blower 42 connected to the air duct 41. The blower 42 is provided with a controller (not shown) for controlling starting/stopping of feeding air through the slit of each of the sections of the air duct 41, flow volume, flow rate, temperature, and humidity of the air. The controller controls the temperature and humidity of the air to be fed and feeding condition thereof independently for each of the sections.

The edge slitting device 16 is provided with a crusher 43 for crushing the side edge portions of the retardation film 14 cut off by the edge slitting device 16 into pieces.

The drying chamber 21 is connected to an adsorption and recovery device 44 for adsorbing and recovering solvent vapor evaporated from the retardation film 14. The cooling chamber 22 is disposed in the downstream side from the drying chamber 21 in the direction B. Additionally, a humidity adjusting chamber (not shown) for adjusting the water content in the retardation film 14 may be disposed between the drying chamber 21 and the cooling chamber 22. The neutralization chamber 23 is a so-called compulsory neutralization device such as a neutralization bar, and adjusts the charged voltage of the retardation film 14 within a predetermined range. The installation position of the neutralization device 23 is not limited to the downstream side from the cooling chamber 22. The pair of knurling rollers 24 provides knurling to the side ends of the retardation film 14 by embossing processing. The winding chamber 25 includes a winding shaft 46 and a press roller 47. The winding shaft 46 is used for winding the retardation film 14. The press roller 47 is used for controlling the tension at the time of winding the retardation film 14.

Next, an exemplary method for producing the retardation film 14 by the solution casting apparatus 10 is described hereinbelow. The dope 11 is cast from the casting die 31 onto the casting drum 32 cooled by the heat transfer medium. It is preferable that the temperature of the dope 11 at the time of casting is constant within a range of 30° C. to 35° C. and the temperature of the peripheral surface of the casting drum 32 is constant within a range of −10° C. to 10° C. Preferably, the temperature of the casting chamber 13 is controlled by the temperature controlling device 36 so as to be within the range of 10° C. to 30° C. Note that, the solvent vapor evaporated in the casting chamber 13 is recovered by the recovery device 38. Thereafter, the recovered solvent vapor is refined and reused as the solvent for use in the dope preparation.

The bead extends from the casting die 31 to the casting drum 32 so as to form the casting film 33 on the casting drum 32. In order to stabilize the shape and state of the bead, the decompression chamber 35 controls pressure in the area in the upstream side from the bead such that the area has pressure at a predetermined value. It is preferable that the pressure in the area in the upstream side from the bead is lower than that in the downstream side from the bead by 10 Pa to 2000 Pa. Note that a jacket (not shown) is preferably attached to the decompression chamber 35 so as to keep the temperature inside the decompression chamber 35 at a predetermined value. The temperature inside the decompression chamber 35 is preferably not less than the condensation point of the solvent contained in the dope 11. The casting film 33 is cooled on the casting drum 32. The cooled casting film 33 turns into a gel state, and hardened, to have a self-supporting property. The hardened casting film 33 is peeled from the casting drum 32 as follows. The film 12 is pulled from the downstream side from the casting drum 32 with the support of a peel roller 51 disposed in the film conveying path. Regardless of the level of residual amount of solvent in the casting film 33, as long as the casting film 33 is hardened enough to be conveyed, it is possible to peel the casting film 33 from the casting drum 32. In a case where the casting film 33 is hardened mainly by cooling instead of drying as described above, it becomes possible to advance the timing of peeling the casting film 33. Therefore, it is possible to decrease the time required for producing the retardation film 14. The time required for producing the retardation film 14 is 35 m/min or less, for example. The time required for producing the retardation film 14 can be further decreased to the range of 45 m/min to 120 m/min.

As the time required for producing the retardation film 14 is decreased, the residual amount of solvent in the casting film 33 at the time of peeling tends to be higher. Therefore, the casting film 33 is preferably cooled such that the cooling speed is improved, namely, the amount of change in temperature decreasing per unit time is increased. In a case where the residual amount of solvent in the casting film 33 is higher than 320%, even if the casting 33 is cooled, the casting film 33 cannot be hardened enough to be conveyed. Additionally, the casting film 33 may be torn at the time of width increasing, because the casting film 33 has not been hardened sufficiently by the start of the width increasing in the tenter 15. Accordingly, the mass of the solvent contained in the casting film 33 at the time of peeling is preferably at most 320% when the mass of the solid content in the casting film 33 is 100%. The residual amount of solvent (unit; %) is a value on dry basis. To be more specific, in the present invention, the residual amount of solvent in the casting film 33 is calculated by a mathematical formula expressed by {x/(y−x)}×100 in which “x” is the mass of the solvent and “y” is the mass of the casting film 33.

The film 12 peeled from the casting drum 32 contains the solvent. The film containing the solvent is guided to the tenter 15. In the tenter 15, the film 12 is conveyed toward the downstream side while the side edge portions thereof are held by pins as a holding means. During the conveyance, heated air is blown to the film 12 through the air duct 41 such that the film 12 is further dried. Additionally, in the tenter 15, the width of the film 12 is increased such that the refractive index of the film 12 in the width direction is increased. Thereby, the film 12 becomes the retardation film 14 having high Re.

The temperature of the film 12 is controlled by the air blown through the air duct 41. The slit of the air duct 41 is provided at the vicinity of the conveying path of the film 12. The controlling of the residual amount of solvent in the film 12, the temperature conditions, and the width of the film 12 to be increased in the tenter 15 is described later by referring to another drawing.

The retardation film 14 is fed from the tenter 15 to the edge slitting device 16. The edge slitting device 16 cuts off the side edge portions of the retardation film 14 which has been held by the pins in the tenter 15. The side edge portions thus cut away are sent to the crusher 43 by a cutter blower (not shown), and then crushed into chips by the crusher 43. The chips of the retardation film 14 are reused to prepare the dope. Thereby, beneficial use of the raw materials can be achieved.

The retardation film 14 whose side edge portions has been cut away is sent to the drying chamber 21 and further dried. In the drying chamber 21, the retardation film 14 is bridged over the rollers 17 and conveyed. The temperature inside the drying chamber 21 is not particularly limited, however it is preferably set at a value within a range of 50° C. to 160° C. It is more preferable that the drying chamber 21 is divided into plural sections in the conveying direction of the retardation film 14 so as to change the temperature of air supplied to each section. In addition, providing a pre-drying chamber (not shown) for pre-drying the retardation film 14 between the edge slitting device 16 and the drying chamber 21 prevents abrupt increase in the temperature of the retardation film 14 in the drying chamber 21, and thereby it is possible to prevent change in shape of the retardation film 14 in the drying chamber 21.

The solvent vapor evaporated in the drying chamber 21 is adsorbed and recovered by the adsorption and recovery device 44. The air, from which the solvent component is removed, is fed as the dry air to the inside of the drying chamber 21 again.

The retardation film 14 is cooled to approximately room temperature in the cooling chamber 22. The neutralization device 23 preferably sets the charged voltage of the retardation film 14 at a value within the range of −3 kV to +3 kV. In addition, preferably, knurling is provided, by the pair of knurling rollers 24, to side ends of the retardation film 14. The height between the highest point and the lowest point of unevenness caused by the knurling is preferably in the range of 1 μm to 200 μm.

The retardation film 14 is wound by using the winding shaft 46 in the winding chamber 25. It is preferable to wind the retardation film 14 while predetermined tension is applied to the retardation film 14 by the press roller 47. It is more preferable to gradually change the tension applied to the retardation film 14 from the start to the end of winding, which prevents excessive tightening of a film roll. It is preferable that a length of the retardation film 14 to be wound is at least 100 m. The width of the retardation film 14 to be wound is preferably in the range of 600 mm to 2500 mm. However, the present invention is also applicable to films having the width of larger than 2500 mm. In addition, the present invention is also applicable to production of thin films having the thickness of 15 μm to 100 μm.

A structure of each of the casting die, the decompression chamber, the support, and the like, the peeling method, stretching, the drying condition in each process, the handling method, curling, the winding method after correcting smoothness, the solvent recovering method, and the film recovering method are described in detail in paragraphs [0617] to [0889] in Japanese Patent Laid-Open Publication No. 2005-104148. The description is also applicable to the present invention.

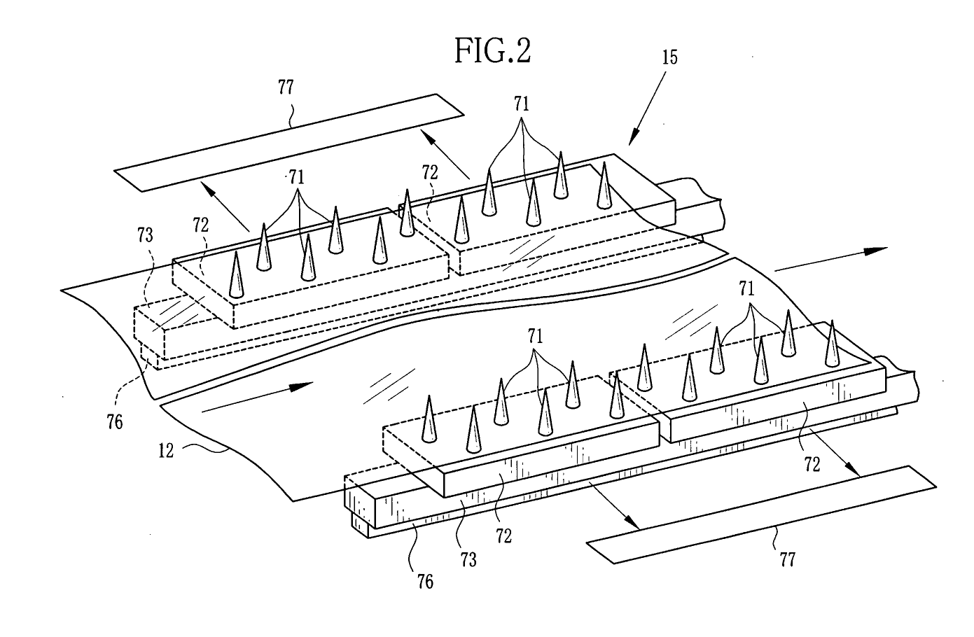

As shown in FIG. 2, the tenter 15 includes pin plates 72, chains 73, rails 76, and the air duct 41 (see FIG. 1) respectively provided at positions corresponding to the side edge portions of the film 12 along the conveying path of the film 12. Each of the pin plates 72 has a plurality of pins 71 as the holding means for the film 12. The plurality of pin plates 72 are attached to each of the chains 73 moving endlessly. Each of the chain 73 is guided by the rail 76. Each of the rails 76 has a shifting mechanism 77. When the film 12 reaches a predetermined position in the tenter 15, the side edge portions of the film 12 are pierced and held by the pins 71. The shifting mechanisms 77 shift the rails 76 in the width direction of the film 12, and thereby the chains 73 move along the rails 76. In accordance with the movements of the chains 73, the pin plates 72 attached to the chains 73 move in the width direction of the film 12 while holding the film 12. Thus, tension is applied to the film 12 in the width direction.

Immediately after being peeled from the casting drum 32 (see FIG. 1), the film 12 contains a large amount of solvent and has an extremely unstable shape. As a result, it is difficult to convey the film 12 using rollers. In addition, the film 12 cannot be held by clips in some cases. For that reason, in this embodiment, the side edge portions of the film 12 are pierced and held by the pins 71. Thus, the film 12 can be conveyed while being held in a stable manner.

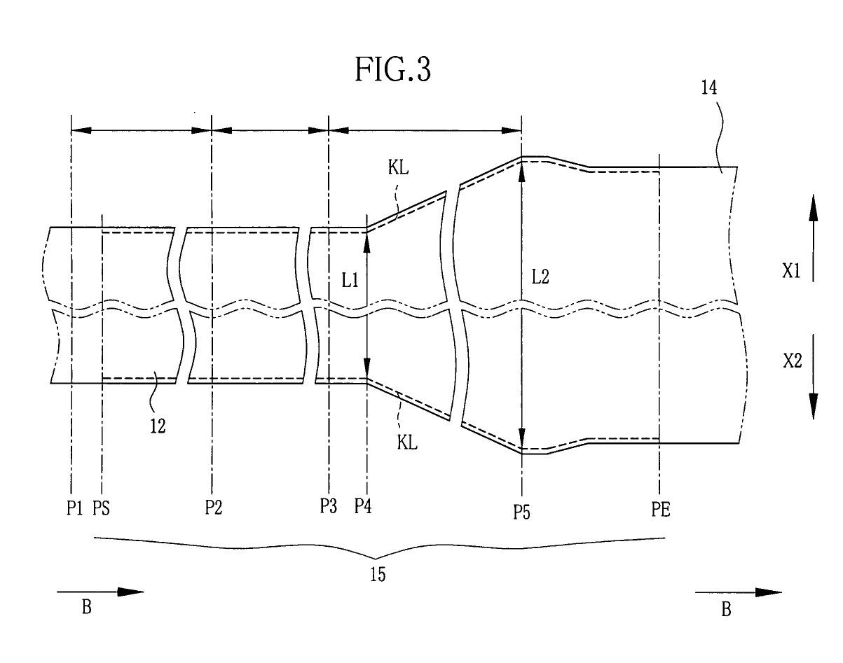

FIG. 3 is an explanatory view of the film 12 from the time of being peeled from the casting drum 32 (see FIG. 1) to the time of being released from the holding with the pins 71 (see FIG. 2) in the tenter 15. The arrow B in the drawing denotes the conveying direction of the film 12. In the tenter 15, tension is applied to the film 12 in the width direction shown by the arrows X1, X2. In the tenter 15, a holding starting position PS is a position at which the holding of the film 12 with the pins 71 is started. A holding ending position PE is a position at which the film 12 is released from the holding with the pins 71. A first position P1 is a position at which the film 12 is peeled from the casting drum 32. Note that an inlet of the tenter 15 is located in the upstream side from the holding starting position PS, and an outlet of the tenter 15 is located in the downstream side from the holding ending position PE. The inlet and the outlet are not shown in FIG. 3. Note that imaginary lines KL denote the innermost positions in the width direction of the side edge portions of the film 12 which are pierced and held by the pins 71.

The solvent gradually evaporates from the film 12 peeled from the casting drum 32 at the first position P1. The solvent further evaporates from the film 12 by the dry air blown to the film 12 through the air duct 41 (see FIG. 1) in the tenter 15. Accordingly, the residual amount of solvent in the film 12 is lower than that in the film 12 just after being peeled from the casting drum 32. The film 12 continues to be dried until the film 12 reaches a second position P2 at which the residual amount of solvent in the film 12 becomes 60 mass %. The process performed between the first position P1 and the second position P2 as described above is hereinafter referred to as a first drying process.

While the residual amount of solvent in the film 12 is at least 60 mass %, a large amount of heat energy of dry air blown to the film 12 through the air duct 41 is consumed for latent heat of vaporization of the solvent contained in the film 12. Therefore, even if the temperature of the dry air blown through the air duct 41 is increased, the temperature of the film 12 itself is not increased significantly. Accordingly, it is possible to increase the temperature of the dry air to be blown to the film 12 up to 120° C. in the first drying process in which the residual amount of the solvent is less than 60 mass %. When the temperature of the dry air to be blown to the film 12 is more than 120° C., the film 12 may foam in some cases. Note that the means for heating the film 12 between the first position P1 and the second position P2 is not especially limited.

Next, while the film 12 is conveyed from the second position P2 to a third position P3 at which the residual amount of the solvent becomes 10 mass %, the dry air is blown to the film 12 through the air duct 41. The process performed between the second position P2 and the third position p3 as described above is hereinafter referred to as a second drying process. The temperature of the dry air in the second drying process is controlled so as to be at most 105° C. Note that, in view of the productivity of the retardation film 14, the temperature of the dry air in the second drying process is preferably at least 40° C., more preferably in the range between 50° C. or more and 95° C. or less, and most preferably in the range between 55° C. or more and 85° C. or less. This is because the evaporation speed of the solvent from the film 12 can be kept at a certain level.

In contrast, when the temperature of the dry air in the second drying process is made higher than 105° C., crazes in addition to voids may be generated in the film 12 at the time of width increasing performed later in some cases. This is because, when the dry air at the temperature of higher than 105° C. is caused to contact with the film 12 in the second drying process, micro voids are generated in the film 12. The micro voids are sources of the voids generated at the time of width increasing. The micro voids are much smaller than the voids generated at the time of width increasing. The micro voids are extremely small and not visible even if using an optical microscope. Since the micro voids are extremely small as described above, clouded portions are not seen in the film 12 at the time of completing the second drying process. However, after the width of the film 12 is increased, the micro voids become large and turn into voids or crazes having a size exhibiting the clouded portions in the conventional methods.

The effect obtained by setting the upper limit of the temperature of the dry air to 105° C. is particularly prominent in a case where the film 12 contains fine particles such as so-called matting agent. In a case where the film 12 contains the fine particles, it is likely that a clearance is generated between the cellulose acylate and the fine particles at the time of width increasing performed later. As in the case of the voids and crazes described above, the clearance also causes the clouded portions in the film 12. To be specific, the clearance causes increase in haze. However, since the film 12 is dried while the upper limit of the temperature of the dry air is set to the value described above, no clearance is generated between the cellulose acylate and the fine particles at the time of width increasing performed later. Note that the preferable diameter of the fine particles for use in the retardation film 14 is in the range of 0.001 μm to 20 μm.

In a case where the residual amount of the solvent in the film 12 is at most 60 mass %, the temperature of the film 12 is easily influenced by the dry air blown to the film 12. Since the amount of the solvent contained in the film 12 is small, the heat energy applied by the dry air is used for not only the latent heat of vaporization of the solvent but also the increase in the temperature of the film 12.

In a case where the dry air at the temperature of at most 105° C. is blown to the film 12 in which the residual amount of the solvent is 60 mass % to dry the film 12, the surface temperature of the film 12 does not exceed its crystallization temperature Tc.

Without applying the tension to the film 12 in the width direction X1,X2 in the tenter 15, the film 12 is loosened due to the self weight or shrinks in the width direction X1,X2 in accordance with evaporation of the solvent. In order to prevent the loosening of the film 12, and further, in order to achieve high Re, according to the present invention, the width of the film 12 is increased by applying tension to the film 12 in the width direction X1,X2. It is preferable to apply the tension to the film 12 symmetrically with respect to a center in the width direction of the film 12. This helps to uniformly control molecular orientation in the film 12 in the width direction.

The width increasing of the film 12 is started at a third position P3 or in the downstream side from the third position P3, which is hereinafter referred to as a width increasing process. Keeping the width of the film 12 is not included in the width increasing process. In this embodiment, the width increasing of the film 12 is started at a fourth position P4 in the downstream side from the third position P3. According to the present invention, the width increasing of the film 12 can be performed as long as the film 12 has been already subjected to the second drying process. Therefore, the timing for starting the width increasing process is not limited to the time when the film 12 reaches the downstream side from the third position P3. Namely, the present invention is not limited to this embodiment, and the width increasing of the film 12 may be started at the third position P3. Hereinbelow, the position at which the width increasing of the film 12 is completed is referred to as a fifth position P5.

Prior to the width increasing process, the film 12 is dried by blowing the dry air at the temperature of at most 105° C. to the film 12 such that the residual amount of the solvent in the film 12 changes from 60 mass % to 10 mass %. Accordingly, no voids and crazes are generated in the film 12 in the width increasing process. Therefore, the transparency of the film 12 is also kept in the width increasing process, and the haze in the obtained retardation film 14 is lower than that in the conventional films.

A glass transition temperature (° C.) of cellulose acylate in the film 12 having the residual amount of the solvent of 10 mass % is denoted by Tg. The temperature of the dry air blown through the air duct 41 is adjusted such that the temperature of the film 12 is within the range between (Tg+10)° C. or more and (Tg+60)° C. or less in the width increasing process. In the width increasing process, the temperature of the film 12 is preferably in the range between (Tg+20)° C. or more and (Tg+50)° C. or less, and more preferably in the range between (Tg+30)° C. or more and (Tg+40)° C. or less.

In a case where the temperature of the film 12 is less than (Tg+10)° C., upon the width increasing, the film 12 may be torn in some cases, unfavorably. In contrast, in a case where the temperature of the film 12 is more than (Tg+60)° C., it becomes impossible to achieve Re of at least 50 nm in the retardation film 14, unfavorably.

Tension is applied to the film 12 in the width direction X1, X2 so as to increase the width of the film 12 such that a width L1 of the film 12 at the fourth position P4 (hereinafter referred to as first width) becomes a width L2 of the film 12 at the fifth position P5 (hereinafter referred to as second width). Each of the first and second widths L1 and L2 is a distance between the opposing film keeping lines KL.

A width increasing ratio of the film 12 in the width increasing process is within the range between 30% or more and 65% or less, more preferably within the range between 40% or more and 60% or less, and most preferably within the range between 45% or more and 55% or less. The width increasing ratio is a ratio of the increased width of the film due to the width increasing with respect to the width thereof before the width increasing. The width increasing ratio of the film 12 is calculated by a mathematical formula expressed by 100×(L2−L1)/L1.

In a case where the width increasing ratio is less than 30%, it is not possible to achieve high Re of at least 50 nm in the film 12. In contrast, in a case where the width increasing ratio is more than 65%, it is likely that the crazes are generated in the film 12, and the haze value tends to be increased. Additionally, the film 12 may be torn in some cases.

In the tenter 15, it is possible to increase the width of the film 12 such that the degree of molecular orientation of cellulose acylate in the film 12 is increased in the width direction X1,X2. Thereby, since the refractive index of the film 12 in the width direction is increased, Re is also increased. Thus, the film 12 becomes the retardation film 14 in which Re is at least 50 nm.

Between the fifth position P5 at which the width increasing process is completed and the holding ending position PE, the width of the film 12 may not be increased such that the width thereof is kept constant, or may be shrunk. Namely, the second width L2 may be kept unchanged in subsequent processes. Alternatively, the second width L2 may be decreased after the width is held as shown in FIG. 3. Either in a case where the second width L2 is kept unchanged or in a case where the second width L2 is decreased, tension is applied to the film 12 in the width direction X1,X2. The film 12 shrinks by its own contractile force when the film 12 is not held by the pins. In order to decrease the second width L2, the width of the film 12 is controlled by adjusting a balance between the contractile force of the film 12 described above and tension applied using the pins.

The solution casting method includes a dry casting method and a cooling casting method. In the dry casting method, the casting film is dried to be hardened on the support and peeled from the support. In the cooling casting method, the casting film is cooled to be hardened on the support and peeled from the support.

The cooling casting method is dramatically superior to the dry casting method from the point of view of productive efficiency, namely, production volume per unit time. Accordingly, it is desirable that the cooling casting method is adopted to produce the retardation film. However, the residual amount of the solvent in the casting film in the cooling casting method is higher than that in the dry casting method. Therefore, in the cooling casting method, the casting film tends to be adhered to the casting drum. Accordingly, it is necessary to pull the casting film strongly in the conveying direction so as to peel the casting film as the film from the casting drum in the cooling casting method. Further, in the cooling casting method, even if the casting film is peeled from the casting drum by pulling the casting film with the force equivalent to that in the dry casting method, due to the pulling force, the casting film or the film having high residual amount of the solvent tends to be stretched more in comparison with the case of the dry casting method. Thereby, the molecules in the film tend to be oriented in the conveying direction B, and refractive index of the film is increased. Therefore, in the cooling casting method, in order to increase Re, the width increasing ratio in the width direction is made higher than that in the dry casting method.

Conventionally, even in the cooling casting method, in order to dry the film prior to the width increasing, the gas at the temperature of more than 105° C. is blown to the film in which the residual amount of the solvent is between 60 mass % and 10 mass %. Therefore, as long as the film is crystallizable, crystallization proceeds in the film before the width increasing. It does not matter whether the film undergoes crystallization or the film does not surely undergo crystallization when the temperature of surface of the film 12 exceeds its crystallization temperature Tc. Accordingly, when the crystallizable film is subjected to the width increasing process to obtain the retardation film, the retardation film contains clouded portions and the haze value in the retardation film is high. On the contrary, according to the present invention, prior to the width increasing process, the gas at the temperature of lower than 105° C. is blown to the film to dry the film such that the residual amount of the solvent in the film changes from 60 mass % to 10 mass %, and then the film is subjected to the width increasing process. Thereby, it is possible to prevent generation of clouded portions in the film and suppress the haze value to low. Accordingly, the present invention is particularly effective in the cooling casting method in which the casting film having a relatively high residual amount of solvent is peeled from the support and dried.

Although the cooling casting method is adopted in this embodiment, the present invention is not limited thereto. It is also possible to adopt the dry casting method using a casting belt endlessly moving instead of using the casting drum.

Although the pin tenter is used in the width increasing process in this embodiment, the present invention is not limited thereto. A clip tenter may be used in the width increasing process if possible. In the clip tenter, clips for holding the side edge portions of the film are used instead of the pins used in the pin tenter.

Next, according to another embodiment, the width increasing process is performed in an off-line manner. In this embodiment, the film is produced and wound as a film roll in a film production process without performing the width increasing process. The film of the film roll thus obtained is stretched by the following off-line stretching apparatus.

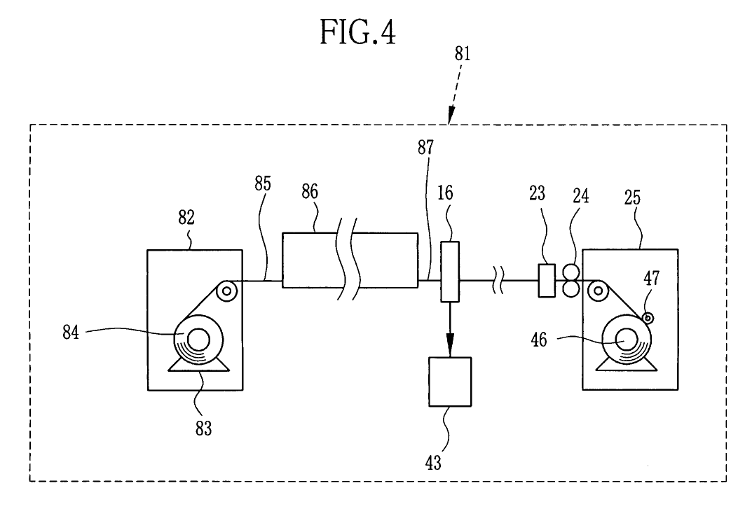

In an off-line stretching apparatus 81 shown in FIG. 4, a film 85 drawn from a film roll 84 is fed to a tenter 86 from a film feeding device 83 provided in a film feeding chamber 82. The width increasing process is performed in the tenter 86. The components equivalent to those in the first embodiment are denoted by the same reference numerals in FIG. 4.

The width increasing process is performed to form a retardation film 87 in the tenter 86. Then, after passing through a cooling chamber (not shown), the retardation film 87 is fed to the winding chamber 25. In the winding chamber 25, the retardation film 87 is wound.

As described above, the width increasing process may be performed by using the off-line stretching apparatus separately from the first and second drying processes. Alternatively, it is possible to perform the first drying process at first, and then perform the width increasing process and the second drying process in the off-line stretching apparatus.

### Example 1

The dope 11 having the following composition was produced.

| | | |
|---|---|---|
| Cellulose acylate | 100 | pts. mass |
| (Triacetyl cellulose having substitution degree of 2.94, | | |
| viscometric average degree of polymerization: 305.6%, | | |
| viscosity of 6 mass % of dichloromethane solution: | | |
| 350 mPa · s) | | |
| Dichloromethane (first component of the solvent) | 390 | pts. mass |
| Methanol (second component of the solvent) | 60 | pts. mass |
| Retardation increasing agent | 9 | pts. mass |
| Citric acid ester mixture (a mixture of citric acid, citric | 0.006 | pts. mass |
| acid monoethyl ester, citric acid diethyl ester, and | | |
| citric acid triethyl ester) | | |
| Fine particles (silicon dioxide having average particle | 0.05 | pts. mass |
| diameter of 15 nm, Mohs hardness: approximately 7) | | |

As the retardation increasing agent, used was N—N′-di-m-toluoyl-N″-p-methoxyphenyl-1,3,5-triazine-2,4,6-triamine.

Plural retardation films 14 were produced using the above dope 11 in the solution casting apparatus 10 shown in FIG. 1. The speed for producing the retardation film 14 was set to 60 m/min. The retardation film 14 was formed so as to have a thickness of 65 μm. The residual amount of solvent in the film 12 at the first position P1 was set to 250 mass %. Next, the first drying process was performed. Namely, the first drying process was performed from the first position p1 at which the residual amount of solvent in the film 12 was 250 mass % to the second position P2 at which the residual amount of solvent in the film 12 was 60 mass %. The temperature of the dry air blown to the film 12 in the tenter 15 in the first drying process was set to 70° C. Next, the second drying process was performed such that the residual amount of solvent in the film 12 changed from 60 mass % to 10 mass %. Namely, the second drying process was performed from the second position P2 to the third position P3 at which the residual amount of solvent in the film 12 was 10 mass %. The temperature of the dry air blown to the film 12 in the second drying process was set to 105° C. In the width increasing process, the temperature of the film 12 was set to Tg+30° C. Note that, Tg denotes a glass transition temperature (° C.) of cellulose acylate in the film 12 in which the residual amount of solvent is 10 mass %. The width increasing ratio was set to 57%. After the width increasing process, the width of the film 12 was kept at L2.

### Example 2

In Example 2, the conditions were the same as those in Example 1 except that the temperature of the dry air blown to the film 12 in the second drying process was set to 90° C.

### Example 3

In Example 3, the conditions were the same as those in Example 1 except that the temperature of the dry air blown to the film 12 in the second drying process was set to 40° C.

### Example 4

In Example 4, the conditions were the same as those in Example 1 except that the temperature of the film 12 in the width increasing process was set to Tg+10° C.

### Example 5

In Example 5, the conditions were the same as those in Example 1 except that the temperature of the film 12 in the width increasing process was set to Tg+60° C.

### Example 6

In Example 6, the conditions were the same as those in Example 1 except that the width increasing ratio of the film 12 in which the residual amount of solvent was 10 mass % was set to 30%.

### Example 7

In Example 7, the conditions were the same as those in Example 1 except that the width increasing ratio of the film 12 in which the residual amount of solvent was 10 mass % was set to 45%.

### Example 8

In Example 8, the conditions were the same as those in Example 1 except that the width increasing ratio of the film 12 in which the residual amount of solvent was 10 mass % was set to 65%.

### Comparative Example 1

In Comparative Example 1, instead of performing the second drying process of Example 1, the dry air at the temperature of 110° C. was blown to the film 12 until the residual amount of the solvent became 55 mass % from 250 mass %, and further the dry air at the temperature of 105° C. was blown to the film 12 until the residual amount of the solvent became 10 mass % from 55 mass % to dry the film 12. Other conditions were the same as those in Example 1.

### Comparative Example 2

In Comparative Example 2, instead of performing the second drying process of Example 1, the dry air at the temperature of 110° C. was blown to the film 12 while the residual amount of the solvent was between 60 mass % and 10 mass % to dry the film 12. Other conditions were the same as those in Example 1.

### Comparative Example 3

In Comparative Example 3, instead of performing the second drying process of Example 1, the dry air at the temperature of 105° C. was blown to the film 12 until the residual amount of the solvent became 15 mass % from 60 mass %. At the time when the residual amount of the solvent became 15 mass %, the width increasing process was started. Namely, at the fourth position P4, the residual amount of the solvent was 15 mass %. The width increasing process was finished before the residual amount of the solvent became 10 mass %. After finishing the width increasing process, until the residual amount of the solvent became 10 mass %, the dry air at the temperature of 110° C. was blown to the film 12 to dry the film 12 completely.

### Comparative Example 4

In Comparative Example 4, the conditions were the same as those in Example 1 except that the temperature of the film 12 in the width increasing process was set to Tg+5° C.

### Comparative Example 5

In Comparative Example 5, the conditions were the same as those in Example 1 except that the temperature of the film 12 in the width increasing process was set to Tg+65° C.

### Comparative Example 6

In Comparative Example 6, the conditions were the same as those in Example 1 except that the width increasing ratio of the film 12 in which the residual amount of solvent was 10 mass % was set to 25%.

### Comparative Example 7

In Comparative Example 7, the conditions were the same as those in Example 1 except that the width increasing ratio of the film 12 in which the residual amount of solvent was 10 mass % was set to 70%.

The Re, Rth, and haze value of the retardation film obtained in Examples 1 to 8 and Comparative Examples 1 to 7 were measured. Conditions for each of the examples and comparative examples, measurement results of the Re, Rth, and haze value, and evaluation results are shown in Table 1.

TABLE 1

| | | | Width | | | |
|---|---|---|---|---|---|---|
| | | Temperature | increasing | | | |
| | | of film in | ratio in | | | |
| | | width | width | | | |
| | Temperature | increasing | increasing | | | Haze |
| | of dry air | process | process | Re | Rth | value |
| | ° C. | ° C. | % | nm | nm | % |
| Ex 1 | 105 | Tg + 30 | 57 | 70 | 210 | 0.5 |
| Ex 2 | 90 | Tg + 30 | 57 | 70 | 210 | 0.4 |
| Ex 3 | 40 | Tg + 30 | 57 | 70 | 210 | 0.4 |
| Ex 4 | 105 | Tg + 10 | 57 | 70 | 200 | 0.5 |
| Ex 5 | 105 | Tg + 60 | 57 | 65 | 220 | 0.3 |
| Ex 6 | 105 | Tg + 30 | 30 | 50 | 210 | 0.3 |
| Ex 7 | 105 | Tg + 30 | 45 | 60 | 210 | 0.3 |
| Ex 8 | 105 | Tg + 30 | 65 | 75 | 210 | 0.4 |
| Com 1 | 110 | Tg + 30 | 57 | 70 | 210 | 1 |
| Com 2 | 110 | Tg + 30 | 57 | 70 | 210 | 1 |
| Com 3 | 110 | Tg + 30 | 57 | 75 | 210 | 1 |
| Com 4 | 105 | Tg + 5 | 57 | 75 | 210 | 0.8 |
| Com 5 | 105 | Tg + 65 | 57 | 45 | 220 | 0.5 |
| Com 6 | 105 | Tg + 30 | 25 | 30 | 190 | 0.5 |
| Com 7 | 105 | Tg + 30 | 70 | 75 | 210 | 1 |

In table 1, “Temperature of dry air” denotes the temperature of the dry air in the second drying process in Examples 1 to 8 and Comparative Examples 4 to 7. “Temperature of dry air” denotes the temperature of the dry air blown to the film in which the residual amount of the solvent is between 250 mass % and 55 mass % in Comparative Example 1. “Temperature of dry air” denotes the temperature of the dry air blown to the film in which the residual amount of the solvent is between 60 mass % and 10 mass % in Comparative Example 2. “Temperature of dry air” denotes the temperature of the dry air blown to the film in which the residual amount of the solvent is between 15 mass % and 10 mass % in Comparative Example 3.

The measurement of Re and Rth was performed by taking a sample from a part of the retardation film 14 wound in the winding chamber 25 and measuring the refractive index in the sample film. Concretely, each value of the Re (unit; nm) was at the refractive index under the condition of 25° C., 60% RH, and each value of the Rth (unit; nm) was at the refractive index under the condition of 25° C., 60% RH. In order to measure the haze value (unit; %), light was applied to the sample film and light transmission was measured under the condition of 25° C., 60% RH. Then, the measured light transmission was substituted for a formula expressed by 100×(scattered light transmission Td/all light transmission Tt).

In excellent retardation films, Re is at least 50 nm, and the haze value is at most 0.5.

Haze value ≦0.5: Excellent

0.5<Haze value: Failure (equivalent to conventional haze values)

In Comparative Examples 1 to 7 not satisfying the conditions of the present invention, the results were as follows. In Comparative Example 1 and 3, the dry air at the temperature of more than 105° C. was blown to the retardation film 14 in which the residual amount of the solvent was less than 60 mass %. Therefore, the haze value was high. In Comparative Examples 2 and 4, the transparency of the retardation film 14 could not be kept, and therefore it was impossible to obtain the retardation film 14 having a low haze value. In Comparative Examples 5 and 6, it was impossible to obtain the retardation film 14 having high Re of at least 50 nm. In Comparative Example 7, since the width increasing ratio was more than 65%, the haze value was high.

On the contrary, in Examples 1 to 8 satisfying the conditions of the present invention, it was possible to obtain the retardation film 14 in which Re was at least 50 nm, and the haze value was at most 0.5. Namely, it is apparent that it is possible to obtain retardation film 14 having high Re and a low haze value.

According to the present invention, it is possible to produce the retardation film in which the haze value is at most 0.5 and Re is at least 50 nm. Since the haze value is at most 0.5, the retardation film can achieve high front contrast on the liquid crystal display.

The present invention is not to be limited to the above embodiments, and on the contrary, various modifications will be possible without departing from the scope and spirit of the present invention as specified in claims appended hereto.

What is claimed is:

1. A retardation film producing method comprising the steps of:
(A) continuously discharging a dope onto a support from a casting die to form a casting film, said dope containing cellulose acylate and a solvent;
(B) peeling said casting film as a film from said support;
(C) drying said film by heating said film until a residual amount of solvent in said film becomes 60 mass %;
(D) drying said film by blowing gas at a temperature of at most 105° C. to said film until the residual amount of solvent in said film changes from 60 mass % to 10 mass %; and
(E) increasing a width of said film after said step (D), while keeping a temperature of said film within a range between Tg+10° C. or more and Tg+60° C. or less, such that a width increasing ratio (%) of said film calculated by a mathematical formula expressed by (L2−L1)/L1×100 becomes a value within a range between 30% or more and 65% or less;
wherein
Tg: a glass transition temperature of said cellulose acylate contained in said film in which the residual amount of solvent is 10 mass %,
L1: a width of said film before the width increasing,
L2: a width of said film after the width increasing.

2. A retardation film producing method as defined in claim 1, wherein said casting film is hardened by cooling said support.
